(19) United States
(12) Patent Application Publication
(10) Pub. No.: US 2014/0297489 A1
(43) Pub. Date: Oct. 2, 2014

(54) SYSTEMS AND METHODS FOR PROVIDING SHARE ASSESSMENT DATA WITH CASH FLOW ANALYSIS

(71) Applicant: Skaffold Pty Limited, Pyrmont (AU)

(72) Inventor: Roger James Montgomery, Pyrmont (AU)

(21) Appl. No.: 14/348,801

(22) PCT Filed: Sep. 28, 2012
(86) PCT No.: PCT/AU2012/001181

§ 371 Date: Mar. 31, 2014

(30) Foreign Application Priority Data
Sep. 29, 2011 (AU) 2011226960

(51) Int. Cl. G06Q 40/00

(52) U.S. Cl. CPC G06Q 40/12
USPC 705/30

(57) ABSTRACT

A computer-implemented method for transforming company performance data thereby to provide cash flow assessment data, the method including: maintaining access to a repository of data for a plurality of shares, wherein the data includes, for each share, company performance data for the company in respect of which the share is issued; receiving, from a client, a cash flow assessment request for a given one of the shares; obtaining from the repository, for the user selected share values for a set of data fields associated with the given one of the shares, wherein values include, for one or more historical periods a profit quantifier a paid dividend quantifier, and one or more cash flow quantifiers; determining a funding gap/surplus quantifier for each historical period wherein each funding gap quantifier is derived from a calculation that accepts inputs including the paid dividends quantifier and one or more of the cash flow quantifiers; defining data indicative of a chart to be displayed by the client, wherein the chart displays, for each historical period, overlaid on common axes, the profit quantifier, the paid dividends quantifier, one or more of the cash flow quantifiers, and the funding gap quantifier; and providing the defined data to the client thereby to allow generation of the chart.

### FIELD OF THE INVENTION

The present invention relates to analysis of share assessment data, and more particularly to systems and methods for analyzing share assessment data pertaining to the cash flow performance of the business entities associated with respective shares. Some embodiments of the invention have been particularly developed to assist users to analyse and understand information relating to stocks, equities or shares and the underlying businesses, so as to make better informed choices in the acquisition and/or disposal of shares from the perspective of “value investing”. It should be appreciated, however, that the invention is not limited to this particular field of use, and is also applicable in other contexts.

### BACKGROUND

The following discussion of the prior art is intended to place the invention in an appropriate technical context and allow the potential advantages of it to be more fully understood. It should be appreciated, however, that any reference in this specification to prior art does not constitute an express or implied admission that such art is widely known or is common general knowledge in the relevant field.

In the field of business investment, various techniques and tools have been developed to assist in understanding the financial performance of businesses that are prospective targets for investment, and also to assist in predicting the future performance of those businesses, and ultimately their shares, equities or stocks. The majority of such techniques and tools are focused on predicting how the share price of a business on a particular stock market will move at some point in the future and therefore rely heavily on factors that are believed to influence the behaviour of the relevant stock, or stock market.

One popular technique is typically referred to as technical analysis or “charting”, whereby professional analysts or traders will evaluate how and when to trade into and out of particular shares or financial markets based on price movements within these markets. This is usually done using pattern-based concepts as “trendlines”, “trend channels”, “support and resistance” levels, “head and shoulder” formations and the like. These are typically reflected graphically in dedicated charts, and interpreted subjectively in combination with related technical indicators such as “historical price volatility”, “moving average convergence/divergence”, “directional movement” indices and the like.

A significant limitation with this approach is that it is based primarily on market-based measures such as share prices or price to earnings (P/E) ratios which are, at least to some extent, extrinsic to the underlying businesses and which are strongly influenced by prevailing market sentiment and perceptions. This in turn results in share price movements that are regularly decoupled from the performance of the underlying businesses in terms direction, magnitude and volatility.

The philosophy and technique of “value investing”, by contrast, places primary emphasis on the evaluation of intrinsic factors that are inherent in the businesses themselves such as earnings per share, return on equity, profitability, debt to equity, and the like. These factors can be analysed independently of the prevailing perceptions and sentiments of the stock market and short-term fluctuations in market pricing. The value investment philosophy is, however, predicated on the expectation that in the long term, the market price for stocks or shares in a business will eventually converge toward or oscillate around the “intrinsic value” of that business.

Hence, the primary objective behind the value investing technique is to establish an estimate of intrinsic value of a business, which may change over time as the business develops, and to acquire shares in the business at a market price that is substantially below that intrinsic value, on the expectation that in the medium to long term, price and intrinsic value will tend to converge. A refinement in the technique is to independently assess the intrinsic quality of businesses and to restrict investments to businesses that are not only trading at a discount to their intrinsic value, but are also of a high quality. This aspect is important because from a value investment perspective, there may be little point in buying shares that are relatively inexpensive if the poor quality of the underlying business does not ultimately justify a higher valuation. Conversely, the quality of superior businesses tends eventually to be reflected in the share price. Assessment of the intrinsic quality of a business can be based on a range of considerations and inputs, including for example inputs related to financial risk and performance.

There have hitherto been numerous software and other tools available to assist analysts, investors and fund managers involved in technical analysis, charting and other popular investment techniques of this type. However, because they are based on a fundamentally different investment philosophy or style (essentially analysing shares rather than businesses) with primary emphasis on extrinsic inputs, they are not readily adapted for use in the context of value investing.

It is an object of the present invention, at least in some embodiments, to overcome or substantially ameliorate one or more of the deficiencies of the prior art, or at least to provide a useful alternative.

### SUMMARY OF THE INVENTION

In a first aspect, the invention provides a computer-implemented method for transforming company performance data thereby to provide cash flow assessment data, the method including:
maintaining access to a repository of data for a plurality of shares, wherein the data includes, for each share, company performance data for the company in respect of which the share is issued;
receiving, from a client, a cash flow assessment request for a given one of the shares;
obtaining from the repository, for the user-selected share, values for a set of data fields associated with the given one of the shares, wherein values include, for one or more historical periods, a profit quantifier, a paid dividend quantifier, and one or more cash flow quantifiers;
determining a funding gap quantifier for each historical period wherein each funding gap quantifier is derived from a calculation that accepts inputs including the paid dividends quantifier and one or more of the cash flow quantifiers;
defining data indicative of a chart to be displayed by the client, wherein the chart displays, for each historical period, overlaid on common axes, the profit quantifier, the paid dividends quantifier, one or more of the cash flow quantifiers, and the funding gap quantifier; and
providing the defined data to the client thereby to allow generation of the chart.

In some embodiments, the chart displays the profit quantifiers and the paid dividends quantifiers in bar form, and the cash flow generation quantifiers and the funding gap quantifiers in line form. It should be appreciated, however, that a variety of alternative graphical symbols and charting styles may be used, including but not limited to cones, columns, cylinders, bubbles, wireframe surfaces, dots and the like.

In some embodiments, for each historical period, the process of determining the funding gap quantifier includes executing a process that accepts as inputs a value for paid dividends (PD), a value for cash flow after investing (CFAI), a value for other financing cash flows (OFCF), and/or a value for foreign exchange effects (FXE).

In some embodiments, for each historical period, the process of determining the funding gap quantifier includes applying the formula:

funding gap quantifier=CFAI−PD+OFCF+FXE

In some embodiments, for each historical period, the cash flow generation quantifier displayed by the chart is a value for, or indicative of, cash flow generated from operations.

In some embodiments, for each historical period, the profit quantifier is a value for, or indicative of, net profits after taxes (NPAT).

In some embodiments, the chart is displayed in a web page that additionally displays numerical values for the profit quantifiers, paid dividend quantifiers, and one or more cash flow quantifiers.

In some embodiments, the method including includes the further step of processing the data indicative of the profit quantifiers, paid dividend quantifiers, funding gap quantifiers and cash flow quantifiers thereby to define a string of plain language prose to explain in plain language one or more cash-flow related observations concerning business performance.

In some embodiments, the chart is displayed in a web page that additionally displays the string of plain language prose.

In some embodiments, the method includes a step of receiving data from one or more external sources, that data including data indicative of profit quantifiers, paid dividend quantifiers, and cash flow quantifiers, and further including a step of updating the repository on the basis of the received data.

In a second aspect, the invention provides a computer-implemented method for transforming company performance data thereby to provide cash flow assessment data, the method including the steps of:
providing, at a client terminal, a web-browser application;
operating the web browser application thereby to display a chart generated in accordance with the method as previously defined herein.

According to a further aspect, the invention provides a computer program product for performing a method as described herein.

According to a further aspect, the invention provides a non-transitive carrier medium for carrying computer executable code that, when executed on a processor, causes the processor to perform a method as described herein.

According to yet another aspect, the invention provides a system configured for performing a method as described herein.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may do so. Furthermore, the particular features, structures or characteristics may be combined in any suitable manner, permutation and combination even if not explicitly disclosed, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms “comprising”, “comprised of” or “which comprises” is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms “including” or “which includes” or “that includes” as used herein is also an open term that means including at least the elements/features that follow the term, but not excluding others. Thus, including is synonymous with, and means the same as, comprising.

### BRIEF DESCRIPTION OF THE DRAWINGS

Embodiments of the invention will now be described, by way of example only, with reference to the accompanying drawings, in which:

FIG. 1 schematically illustrates a system according to one embodiment of the invention;

FIG. 2 illustrates a method according to one embodiment;

FIG. 3 illustrates we web-delivery framework according to one embodiment;

FIG. 4A illustrates a chart generated according to one embodiment; and

FIG. 4B illustrates a screenshot generated according to one embodiment.

### DETAILED DESCRIPTION

Described herein are systems and methods for providing share assessment data. For example, one embodiment takes the form of a computer implemented method performed by a web server for delivering data to client terminals, thereby to enable the rendering of share assessment data in chart form. The web server provides a client interface (which is renderable in a client web browser), this interface being configured to display a plurality of charts. One of these charts displays, overlaid on common axes, a set of historical/forecasted profit quantifiers, a paid dividends quantifier, one or more cash flow generation quantifiers, and a funding gap quantifier.

Other embodiments include related methodologies performed by client terminals, both in the context of executing web-delivered code from a web server, and in the context of executing local proprietary applications. Some embodiments include hardware components and/or carrier media associated with the implementation of such methodologies.

### Exemplary System

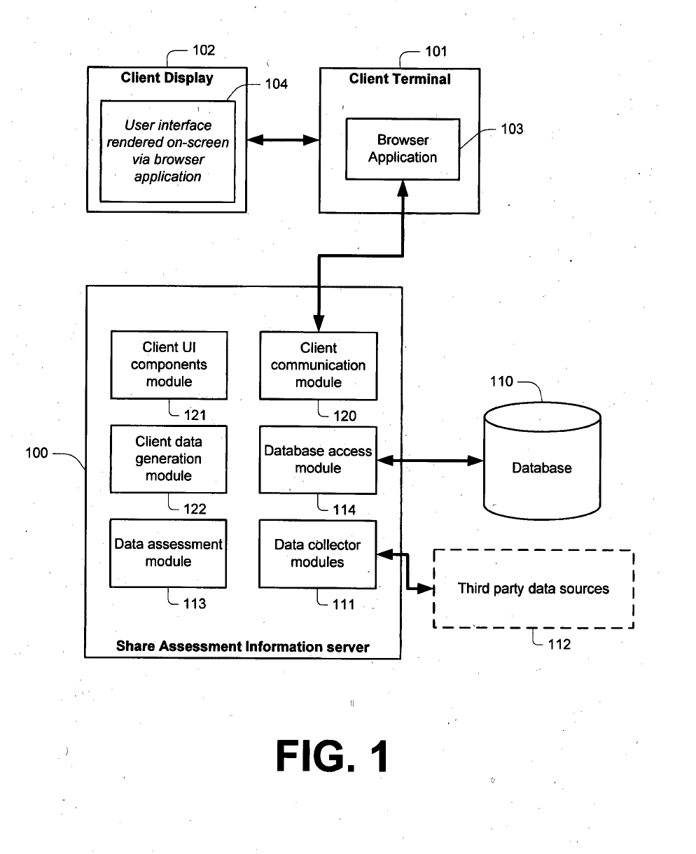

FIG. 1 illustrates an exemplary system whereby a share assessment information server 100 delivers computer executable code to a plurality of client terminals via the Internet. An exemplary client terminal 101 is illustrated in combination with an associated client display 102. A browser application 103 (such as Microsoft Internet Explorer or Google Chrome) executes on client terminal 101. Code delivered by server 100 is rendered via browser application 103 thereby to provide an on-screen rendering 104 of a client interface provided by server 100.

It should be appreciated that the example of a browser/server arrangement is exemplary only. In some embodiments, a proprietary application executes on terminal 101, that proprietary application including computer executable code for allowing terminal 101 to perform various functionalities of server 100 discussed below. For example, such an approach is in some cases preferable for mobile device applications, such as applications coded for iPhone or Android platforms.

In overview, server 100 is configured for performing various computer-implemented methods for providing share assessment data. In some cases, such a method includes maintaining access to a repository of data for a plurality of shares. In the context of FIG. 1, that data is maintained in database 110. As used herein, the expression “maintaining access” requires only that server 100 is able to access data in database 110 as needed. That is, the access need not be continuous; but may be periodic or spasmodic. In some cases database 110 is physically housed at a location remote of server 100 (optionally jurisdictionally remote). Additionally, it will be appreciated that server 100 and/or database 110 may be defined by a plurality of distributed components.

The term “share assessment data”, and other references to information concerning shares, should be read broadly to include data and/or information concerning the entity in respect of which the share is issued. For example, share assessment data may include a wide range of company financial information, such as revenue, expense, profit and cash flow information, as well as other quantitative or qualitative data.

In the embodiment of FIG. 1, server 100 includes data collector modules 111 that are configured to obtain information from third party data sources 112. For example, modules 111 are configured to extract data from RSS feeds or the like, such that database 110 is able to be updated with new information. In the illustrated embodiment a data assessment module 113 receives data from collector modules 111 and processes that data into a form appropriate for input to database 110. A database access module 114 is configured to input the new data into database 110. Database access module 114 is additionally configured for performing other database operations, such as handling database queries and the like.

As foreshadowed above, server 100 is configured to provide a client interface for clients, such as client 101. In this regard, server 100 includes a client communication module 120, which is responsible for handling the delivery of data to clients, and the receipt of data from clients. For example, module 120 is configured for receiving data indicative of the interaction of a user of client terminal 101 with the client interface (as rendered on display 103). The received data is processed, for example to allow handling of requests for new pages, elements, objects, refreshed renderings, and so on. A client UI components module 121 is configured for defining UI components that are to be delivered to client terminal 101 via module 120. A client data generation module 122 is configured to generate specific data for display at client terminal 102, such as charts, diagrams, and the like. That is, at a general level, module 121 defines objects configured to contain data, and module 122 generates the data to be contained in those objects.

### Generation of Charts

Among a range of other functionalities, the client interface provided by server 100 and rendered at client terminal 101 is configured to display a plurality of charts (although not necessarily simultaneously; in some embodiments the charts may be displayed one at a time). The embodiments discussed herein are particularly focused on the generation and presentation of such charts.

In overview, for the charts considered herein, each chart provides information regarding a selection of the shares for which data is maintained in database 100. In some cases the selection is defined by all of the available shares for which data is stored. However, more preferably, one or more rules/filters are applied thereby to transform the full gamut of shares to a reduced selection. For example, one filter excludes all shares having zero intrinsic value, according to a predefined intrinsic valuation algorithm.

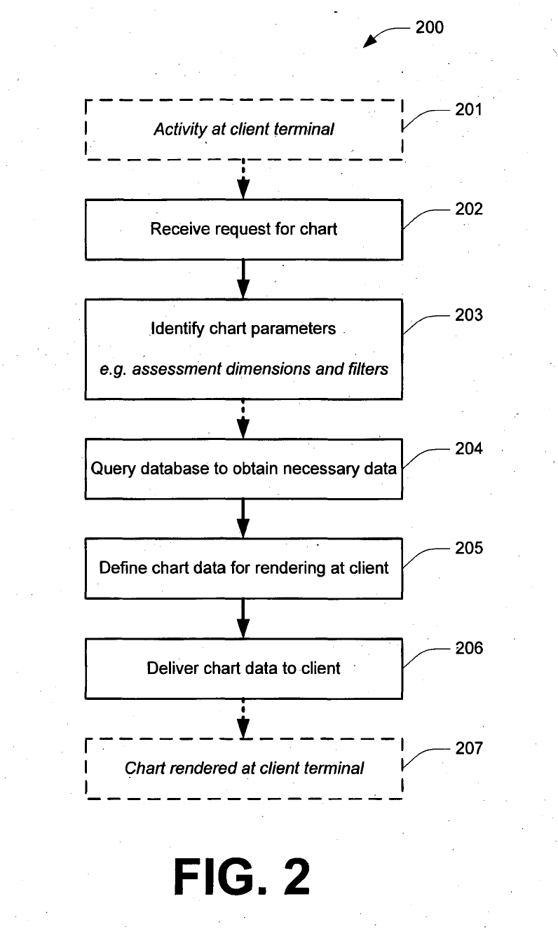

FIG. 2A illustrates a computer implemented method according to one embodiment, this method being performed in substance by server 100, thereby to allow a chart to be displayed at client terminal 101. In FIG. 2A, functional blocks bordered by dashed lines represent processes performed by components other than server 100.

Functional block 201 represents a process whereby activity occurs at client terminal 101, specifically in terms of interaction between a user and the client interface which results in a request to display a chart. For example, this might include the user navigating to a page that is configured to display a particular chart. This results in a request for a chart being received by server 100 at 202. Server 100 then identifies chart parameters at 203. The term “chart parameters” describes factors such as assessment dimensions (for example an x-axis assessment dimension and y-axis assessment dimension in the context of a line chart or scatter chart) and filters (for example whether the chart is to display data for a single share, a defined group of shares meeting specific requirements, and so on). In some cases predefined sets of chart parameters are stored to simplify this process (for example the request may be to provide “chart type #1234”). Based on the chart parameters, server 100 conducts a query of database 110 (via module 114) at 204 thereby to obtain the data necessary to generate that chart. Module 122 is then operated at 205 to define data for rendering of the relevant chart at terminal 101, with this data being provided to terminal 101 at 206. Terminal 206 then renders the relevant chart at 207.

It will be appreciated that FIG. 2A is an exemplary method only, and that in other embodiments modified methods are used. For example, optimizations are optionally incorporated into the methodology thereby to reduce latency between client requests and chart data provision, and/or to allow an already-rendered chart to be updated with new data and/or parameters (such as filters).

In some cases, for each of the selections of the shares that are to be displayed in a chart, respective graphical markers are used to illustrate the attributes of each share in the selection relative to a set of assessment dimensions. For example, the chart may be a scatter chart, and a graphical marker (such as a dot, cross, or the like) is used to identify the position of each share on the chart relative to the assessment dimensions (which are displayed on the x-axis and y-axis).

Preferably, each graphical marker includes a link to a page or object provided by the client interface that displays additional information regarding the share to which that graphical marker relates. That is, by clicking on a graphical marker, a user is provided with additional “drill-down” information concerning the relevant share (optionally including access to further share-specific charts). In some cases the client interface is configured such that hovering a cursor over a given marker provides “pop-up” information (such as company name, key financial statistics and the like).

### Assessment of Cash Flow

In some embodiments, server 100 is configured to provide a chart that facilitates assessment of company cash flow. In the context of method 200, this is triggered at 201 by activity at a client terminal indicative of a cash flow assessment request for a given one of the shares. For example, a user selects a particular share, and clicks a button thereby to request such an assessment.

In this case, database 110 includes, for each share, company performance data for the company in respect of which the share is issued. Step 204 includes obtaining from the database for the user-selected share, values including values indicative of:
A profit quantifier. This is preferably Net Profit after Taxes (NPAT) as reported for a given period such as a financial year, although it will be appreciated that other profit quantifiers may be used including, for example, an adjusted NPAT quantifier derived by removing extraordinary, abnormal or one-off revenue or expense items from a reported NPAT value.
A paid dividend quantifier (PD), which quantifies the value of dividends paid to shareholders for a given period.
One or more cash flow quantifiers. Preferably, these include a value for cash flow after investing (CFAI), a value for other financing cash flows (OFCF), a value for foreign exchange effects (FXE), and a value for cash flow generated from normal operations. One or more of these may be derived subject to calculations based on data in database 110.

These values are obtained for one or more historical periods. For example, in one embodiment, a yearly value is obtained for each of a plurality of preceding years. In some cases forecast future values are also used. It will be appreciated that, from a data processing and chart generation perspective, whether values are real historical values or predicted/forecast future values is not material.

In the context of the present assessment, step 205 includes determining a funding gap quantifier for each historical period (noting that in some cases the “funding gap” quantifier is in practice a “funding surplus” quantifier, and hence any references to “funding gap” should be understood to encompass the possibility of a negative funding gap, or in other words a funding surplus, and vice versa). Each funding gap quantifier is preferably derived from a calculation that accepts inputs including the paid dividends quantifier and one or more of the cash flow quantifiers. For example, one approach is, for each historical period, to determine the funding gap quantifier by applying the following formula:

funding gap/surplus quantifier=CFAI−PD+OFCF+FXE

For example, if the Cash Flow After Investing (CFAI) was $10m and the business paid $45m in dividends, assuming no other relevant movements, then the funding gap would be $35m. This implies that the business would need to draw on existing cash reserves, or to raise additional equity capital or debt, in order to fund the operations of the business from that point. Alternatively, if CFAI was $100m and business paid $45m in dividends, assuming no other material movements, then the business would have a funding surplus of $55m. In other words, the business would have surplus cash from normal operations from which to accumulate cash reserves, pay additional dividends, fund share buybacks, retire debt or make acquisitions, without the need for external financing.

Step 205 then includes the step of defining data indicative of a chart to be displayed by the client, wherein the chart displays, overlaid on common axes, the profit quantifiers and the paid dividend quantifiers in bar form, and one of the cash flow generation quantifiers and the funding gap quantifiers in line form. The defined data to the client at 206 thereby allows display of the chart at the client terminal at 207.

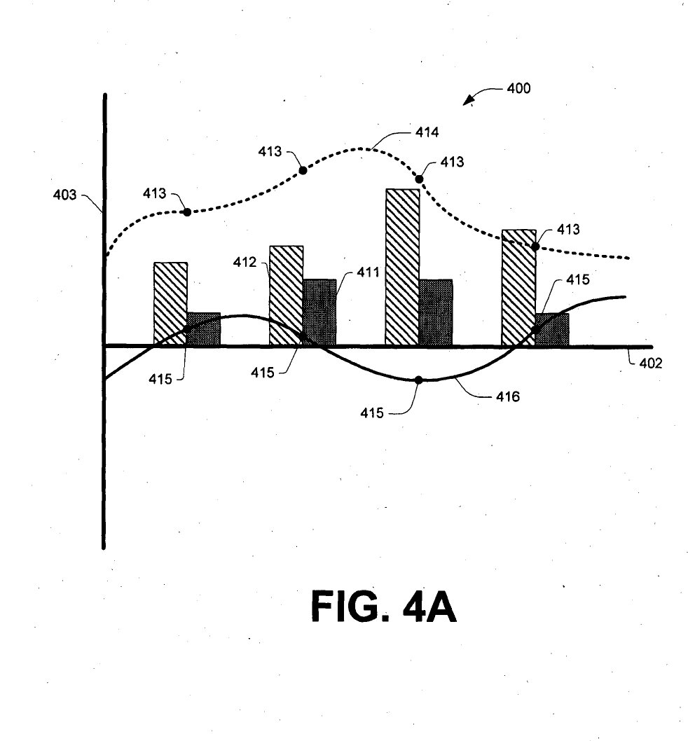

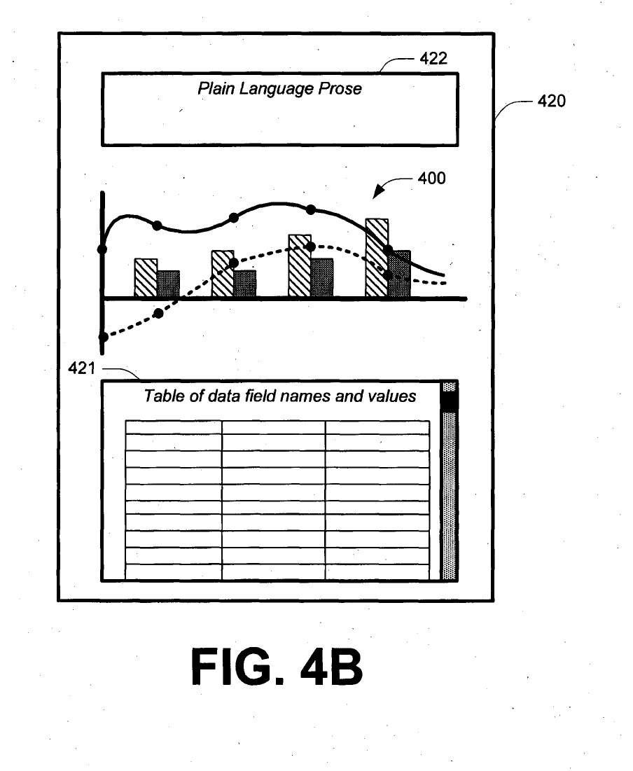

An exemplary chart 400 generated using the above-describe approach is provided in FIG. 4A. Axis 402 is in essence a timeline, although rather than being graduated, each historical period is defined by a region including two bars and a marker point for each line. In this manner, there is a single data value displayed for each bar and line for each historical period. Axis 403 is a monetary value, being positive above the line origin and negative below the line origin. Preferably the scale of this axis is determined at step 205 based on the values being displayed on the chart, thereby to provide a visually effective fit and intuitive presentation format.

Bars carrying the shading of bar 411 are indicative of the cash dividends for each historical period. Bars carrying the shading of bar 412 are indicative of the reported NPAT. Points 413 on line 414 are indicative of values for cash flow generated from operations for each historical period. Points 415 on line 416 are indicative of values of the cash flow funding gap (or surplus) for each period. It will be appreciated that where line 416 is below axis 402, that indicates a funding gap, whereas where line 416 is above axis 402, that indicates a funding surplus.

A chart generated in the manner of chart 400 is particularly useful in that it enables an analyst or investor to develop a quick and intuitive understanding of how cash is actually flowing into and out from the business as distinct from the NPAT figures that are typically reported in the Profit and Loss statements in the company's accounts. These reported NPAT figures are usually based on accrual accounting methodologies but can often provide an incomplete, and sometimes a misleading, picture in terms of the cash position, cash needs and ultimately the financial health of the business. The significance of this is to allow analysts or investors to quickly and simply determine whether, in the case that a business is reporting profits, those profits are supported or backed up by net cash flowing into the business. There are situations where a business may be reporting profits using aggressive or “creative” accounting techniques, and yet be losing cash or have negative operating cash flow.

This is a situation which investors would often wish to avoid, on the basis that a business that is reporting positive accounting profits can easily fail if starved of cash, even temporarily. This is particularly so in small to medium sized enterprises, which are often more constrained than larger businesses in terms of their ability to raise cash on short notice through additional debt or equity. However, it can also be a cause of catastrophic failure in large businesses, particularly if highly leveraged. Conversely, businesses that generate healthy levels of surplus cash on a sustained basis rarely fail, irrespective of the level of reported NPAT.

The other elements in chart 400 show the net use of the cash flow through the funding surplus or gap which takes into account the businesses operations (investment spend, dividends, etc). Basically, this tells an investor how much cash is left after the businesses finishes all of its activities. At this point, if the residual cash is negative, then the business will require external financing (if cash at bank is not available) to fund its operations and pay its dividends. Even if external financing is available, this increases the debt/equity ratio of the business which, if continued over time, lowers the attractiveness and the value of the business from an investment perspective. Conversely, if the residual cash is positive, as graphically and intuitively indicated in the chart by a positive funding surplus, this indicates that the business has ample cash to pay dividends, boost its bank balance, undertake strategic acquisitions or development projects, etc. Clearly, this is a far more attractive proposition from an investment perspective, subject to other relevant considerations.

In some cases, as shown in the exemplary screenshot of FIG. 4B, chart 400 is displayed in a web page 420 that additionally displays a table 421 of numerical values for the profit quantifiers, paid dividend quantifiers and cash flow quantifiers and an object 422 that provides a plain language prose explanation of the performance assessment. Generating object 322 includes processing the data indicative of the profit quantifiers, paid dividend quantifiers and cash flow quantifiers thereby to define a string of plain language prose to explain in plain language one or more performance-related observations.

As context, server 100 is configured for transforming share assessment data into plain language. For example, in some cases module 122 is configured to execute a plain language conversion algorithm thereby to generate a string of plain language prose based on information in database 110. This string of plain language prose is defined in a manner intended to convey or explain the meaning and/or relevance of various data field values in database 110 in the context of a particular form of assessment, such as comparative analysis for the purpose of value investing. As used herein, the notion of “plain language” refers to the use of words, phrases and/or sentences in combination with numerical values, to provide those numerical values with verbal context and meaning. The words, phrases or sentences are grouped into a string (optionally being separated into paragraphs or bullet-style points) thereby to provide a string of meaningful and natural prose that is readable by a user.

The following steps provide an exemplary partial algorithm for providing an assessment of the cash flow performance of a business, in terms of a funding gap (or surplus). In this embodiment, a different algorithm format has been used as compared with the example above.
(i) Set Company Name value to value1.
(ii) Set Reported Net Profit After Taxes value to value2.
(iii) If value2 positive, set StringMod1 to “Net Profit After Taxes”.
(iv) If value2 negative, set StringMod1 to “Net Loss After Taxes”.
(v) Set Cash Flow from Operations value to value3.
(vi) Determine Cash Flow Ratio value (value3/value2).
(vii) Set Cash Flow Ratio value to value4.
(viii) Set Invested Amount value to value5.
(ix) Set Dividends Paid value to value6.
(x) Determine Other Payments value.
(xi) Set Other Payments value to value7.
(xii) Determine Surplus/Gap value (Surplus/Gap=Cash Flow After Investing−Dividends Paid+Other Financing Cash Flow+Foreign Exchange Effects).
(xiii) IF Surplus/Gap value positive, set StringMod2 to “funding surplus of [Surplus/Gap value], ELSE set StringMod2 to “funding gap of [Surplus/Gap value].
(xiv) IF Surplus/Gap value positive, set StringMod3 to “This surplus indicates that [value2] does not rely on external sources of capital to fund business activities”, ELSE set StringMod3 to “this gap must be funded from potentially dilutive capital raisings, additional borrowings, or available cash”.
(xv) Complete string portions:
   Since [value1], [value2] has reported [StringMod1] of [value2] and generated [value3] in Cash Flow from Operations. This amounts to a Cash Flow Ratio (which measures the quality of reported earnings) of [value4]. Greater than 0.80 is preferable.
   Over the same period, [value2] has invested [value5], paid dividends of [value6], and has paid out other financing cash flows and foreign exchange of [value7]. The total of these business activities when compared to Cash Flow from Operations produces a [StringMod2].
   [StringMod3].

Using this algorithm, and a set of example values, the following string may be generated:
Since 2001, XYZ Corporation has reported Net Profit After Taxes of $158.349M and generated $169.047M in Cash Flow from Operations. This amounts to a Cash Flow Ratio (which measures the quality of reported earnings) of 1.07. Greater than 0.80 is preferable.
Over the same period, XYZ Corporation has invested $68.346M, paid dividends of $92.865M, and has paid out other financing cash flows and foreign exchange of $2.088M. The total of these business activities when compared to Cash Flow from Operations produces a funding surplus of $5.685M.
This surplus indicates that XYZ Corporation does not rely on external sources of capital to fund business activities

It will be appreciated that this automated approach usefully provides understandable context to the underlying data, in plain language.

The present three-way presentation approach is particularly significant as it provides both verbal and graphical context to the detailed (but often more difficult to understand or interpret) numerical data values in table 421. In this manner, a user is provided with useful context to understand the significance of these values in relation to the associated shares and underlying businesses. This in turn allows the user to better understand the influences and implications in terms of investment risk and return, thereby to make better informed investment decisions. This understanding and insight may also be valuable to those directly involved in the management or governance of such businesses.

### Exemplary Web-Delivery Framework

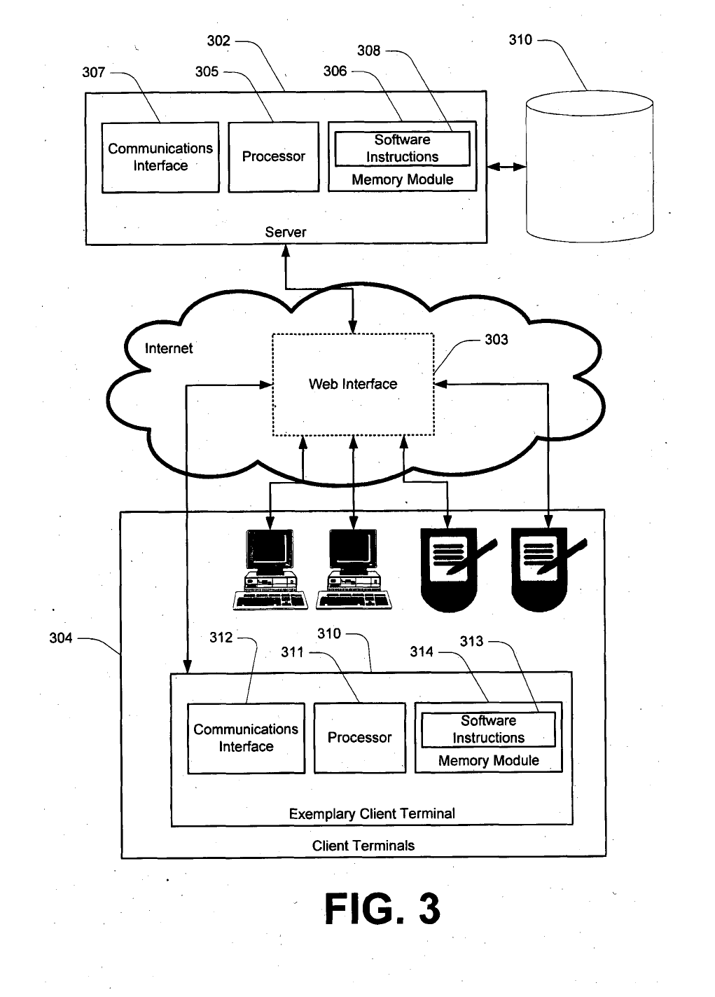

In some embodiments, methods and functionalities considered herein are implemented by way of a server, as illustrated in FIG. 3. This figure, and the following explanation, is provided as additional context to web delivery frameworks. In overview, a web server 302 provides a web interface 303. This web interface is accessed by the parties by way of client terminals 304. In overview, users access interface 303 over the Internet by way of client terminals 304, which in various embodiments include the likes of personal computers, PDAs, cellular telephones, gaming consoles, and other Internet enabled devices.

Server 303 includes a processor 305 coupled to a memory module 306 and a communications interface 307, such as an Internet connection, modem, Ethernet port, wireless network card, serial port, or the like. In other embodiments distributed resources are used. For example, in one embodiment server 302 includes a plurality of distributed servers having respective storage, processing and communications resources. Memory module 306 includes software instructions 308, which are executable on processor 305.

Server 302 is coupled to a database 310. In further embodiments the database leverages memory module 306.

In some embodiments web interface 303 includes a website. The term “website” should be read broadly to cover substantially any source of information accessible over the Internet or another communications network (such as WAN, LAN or WLAN) via a browser application running on a client terminal. In some embodiments, a website is a source of information made available by a server and accessible over the Internet by a web-browser application running on a client terminal. The web-browser application downloads code, such as HTML code, from the server. This code is executable through the web-browser on the client terminal for providing a graphical and often interactive representation of the website on the client terminal. By way of the web-browser application, a user of the client terminal is able to navigate between and throughout various web pages provided by the website, and access various functionalities that are provided.

Although some embodiments make use of a website/browser-based implementation, in other embodiments proprietary software methods are implemented as an alternative. For example, in such embodiments client terminals 304 maintain software instructions for a computer program product that essentially provides access to a portal via which framework 100 is accessed (for instance via an iPhone app or the like).

In general terms, each terminal 304 includes a processor 311 coupled to a memory module 313 and a communications interface 312, such as an internet connection, modem, Ethernet port, serial port, or the like. Memory module 313 includes software instructions 314, which are executable on processor 311. These software instructions allow terminal 304 to execute a software application, such as a proprietary application or web browser application and thereby render on-screen a client interface and allow communication with server 302. This client interface allows for the creation, viewing and administration of profiles, access to the internal communications interface, and various other functionalities.

### CONCLUSIONS AND INTERPRETATION

It will be appreciated that the disclosure above provides various significant systems and methods for providing share assessment data, particularly in terms of transforming share assessment data into plain language. In this manner, a user is provided with useful context to understand how these figures change better shares, and their meanings, thereby to make better informed investment decisions.

Unless specifically stated otherwise, throughout the specification terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1.-15. (canceled)

16. A computer-implemented method for transforming company performance data thereby to provide cash flow assessment data, the method including:
maintaining access to a repository of data for a plurality of shares, wherein the data includes, for each share, company performance data for a company in respect of which the share is issued;
receiving, from a client, a cash flow assessment request for a given one of the shares;
obtaining from the repository, for the given one of the shares, values for a set of data fields associated with the given one of the shares, wherein the values include, for one or more historical periods, a profit quantifier, a paid dividends quantifier, and one or more cash flow quantifiers;
determining a funding gap quantifier for each historical period wherein each funding gap quantifier is derived from a calculation that accepts inputs including the paid dividends quantifier and the one or more of the cash flow quantifiers;
defining data indicative of a chart to be displayed by the client, wherein the chart displays, for each historical period, overlaid on common axes, the profit quantifier, the paid dividends quantifier, the one or more of the cash flow quantifiers, and the funding gap quantifier; and
providing the data indicative of the chart to the client thereby to allow generation of the chart.

17. The computer-implemented method of claim 16, wherein the chart displays the profit quantifier and the paid dividends quantifier in bar form, and the one or more cash flow quantifiers and the funding gap quantifiers in line form.

18. The computer-implemented method of claim 16, wherein, for each historical period, determining the funding gap quantifier includes executing a process that accepts as inputs a value for paid dividends (PD), a value for cash flow after investing (CFAI), a value for other financing cash flows (OFCF), and a value for foreign exchange effects (FXE).

19. The computer-implemented method of claim 18, wherein, for each historical period, determining the funding gap quantifier includes applying formula:
the funding gap quantifier=CFAI−PD+OFCF+FXE.

20. The computer-implemented method of claim 16, wherein, for each historical period, the one or more cash flow quantifiers displayed by the chart is a value for cash flow generated from operations.

21. The computer-implemented method of claim 16, wherein, for each historical period, the profit quantifier is a value for net profits after taxes (NPAT).

22. The computer-implemented method of claim 16, wherein the chart is displayed in a web page that displays numerical values for the profit quantifier, the paid dividends quantifier, and the one or more cash flow quantifiers.

23. The computer-implemented method of claim 16, further comprising:
processing the data indicative of the profit quantifier, the paid dividends quantifier, funding gap quantifier and the one or more cash flow quantifiers thereby to define a string of plain language prose to explain in plain language one or more cash-flow related observations.

24. The computer-implemented method of claim 23, wherein the chart is displayed in a web page that displays the string of plain language prose.

25. The computer-implemented method of claim 16, further comprising:
receiving data from one or more external sources, that data including data indicative of profit quantifiers, paid dividend quantifiers, and cash flow quantifiers; and
updating the repository based on the data received from the one or more external sources.

26. The computer-implemented method of claim 16, further comprising:
providing, at the client, a web-browser application; and
operating the web-browser application thereby to display the chart.

27. A non-transitive carrier medium comprising computer executable code that, when executed on a processor, causes the processor to:
maintain access to a repository of data for a plurality of shares, wherein the data includes, for each share, company performance data for a company in respect of which the share is issued;
receive, from a client, a cash flow assessment request for a given one of the shares;
obtain from the repository, for the given one of the shares, values for a set of data fields associated with the given one of the shares, wherein the values include, for one or more historical periods, a profit quantifier, a paid dividends quantifier, and one or more cash flow quantifiers;
determine a funding gap quantifier for each historical period wherein each funding gap quantifier is derived from a calculation that accepts inputs including the paid dividends quantifier and the one or more of the cash flow quantifiers;
define data indicative of a chart to be displayed by the client, wherein the chart displays, for each historical period, overlaid on common axes, the profit quantifier, the paid dividends quantifier, the one or more of the cash flow quantifiers, and the funding gap quantifier; and
provide the data indicative of the chart to the client thereby to allow generation of the chart.

28. The non-transitive carrier medium of claim 27, wherein the computer executable code that, when executed on the processor, further causes the processor to:
display the chart including the profit quantifier and the paid dividends quantifier in bar form, and the one or more cash flow quantifiers and the funding gap quantifiers in line form.

29. The non-transitive carrier medium of claim 27, wherein the computer executable code that, when executed on the processor, further causes the processor to:
for each historical period, determine the funding gap quantifier includes executing a process that accepts as inputs a value for paid dividends (PD), a value for cash flow after investing (CFAI), a value for other financing cash flows (OFCF), and a value for foreign exchange effects (FXE).

30. The non-transitive carrier medium of claim 29, wherein the computer executable code that, when executed on the processor, further causes the processor to:
for each historical period, determine the funding gap quantifier includes applying formula:
the funding gap quantifier=CFAI−PD+OFCF+FXE.

31. The non-transitive carrier medium of claim 27, wherein, for each historical period, the one or more cash flow quantifiers displayed by the chart is a value for cash flow generated from operations.

32. The non-transitive carrier medium of claim 27, wherein, for each historical period, the profit quantifier is a value for net profits after taxes (NPAT).

33. The non-transitive carrier medium of claim 27, wherein the computer executable code that, when executed on the processor, further causes the processor to:
display the chart in a web page that displays numerical values for the profit quantifier, the paid dividends quantifier, and the one or more cash flow quantifiers.

34. The non-transitive carrier medium of claim 27, wherein the computer executable code that, when executed on the processor, further causes the processor to:
process the data indicative of the profit quantifier, the paid dividends quantifier, funding gap quantifier and the one or more cash flow quantifiers thereby to define a string of plain language prose to explain in plain language one or more cash-flow related observations.
